(19) United States
(12) Patent Application Publication
(10) Pub. No.: US 2007/0274428 A1
(43) Pub. Date: Nov. 29, 2007

(54) NATURAL CIRCULATION TYPE BOILING WATER REACTOR

(76) Inventors: Masao CHAKI, Hitachi (JP); Tetsushi Hino, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/668,028

(22) Filed: Jan. 29, 2007

(30) Foreign Application Priority Data
Feb. 28, 2006 (JP) 2006-051513

(51) Int. Cl. G21C 19/42

(52) U.S. Cl. 376/308

(57) ABSTRACT

The natural circulation type boiling water reactor comprises a core in which a plurality of fuel assemblies are loaded, and a chimney which is disposed above the core and has a path partition which forms a plurality of vertical lattice paths. A uniform pressure space is formed between the core and the chimney and not disposed the path partition. The two-phase flow including the cooling water and the steam exhausted from the core through the uniform pressure space is supplied to the vertical lattice paths. The two-phase flow ascends in the vertical lattice paths. Thus, the flow distribution for each fuel assembly can be calculated using the pressure difference between the upper end and the lower end of the core can be calculated without the need for the void fraction of the lattice paths.

### CLAIM OF PRIORITY

The present application claims priority from Japanese application serial no. 2006-051513, filed on Feb. 28, 2006, the content of which is hereby incorporated by reference into this application.

### BACKGROUND OF THE INVENTION

The present invention relates to a natural circulation type boiling water reactor which makes thermal margin evaluation of a core possible, using the same method as that for a conventional forced circulation type boiling water reactor.

The circulation path of the cooling water (coolant) in a reactor pressure vessel of the natural circulation type boiling water reactor is formed by utilizing the cylindrical chimney which is provided at the upper portion of the core and the core shroud which encloses the periphery of the core. The downcomer is formed between the outer peripheral surface of the core shroud and chimney and the inner surface of the reactor pressure vessel. Coolant circulates in the downcomer, with the downcomer being the descending path and inside the core and the chimney with the inside thereof being the ascending path.

Because this circulation paths is formed inside of the reactor pressure vessel, the cooling water which has received heat being generated by nuclear reaction and has been heated thereby becomes a two-phase flow, that is, the cooling water including steam. This cooling water exhausted from the core ascends into the chimney, and is separated into liquid and gas at the separator provided at the upper part of the chimney. The steam is then supplied to the turbine outside the reactor pressure vessel and the liquid (cooling water) is returned to the descending path.

Unlike the coolant in the chimney, because the coolant in the descending path is a liquid phase with low temperature and high density, it descends by natural circulation based on this density difference. The descending liquid is reversed to the upper side near the bottom of the reactor pressure vessel and is introduced into the core once again. The cooling water is heated in the core. In this manner, the cooling water is circulated naturally in the reactor pressure vessel without using a pump (see Japanese Patent Laid-open No. Hei 8(1996)-094793 (Paragraphs No. 0002-0006) for example).

For this reason, the most important feature of the natural circulation type boiling water reactor is that the system and devices for circulating the coolant are simple when compared to the forced circulation type boiling water reactor in which cooling water is circulated by being forced using a pump.

In order to circulate the coolant efficiently, the ascending path in the chimney is divided into multiple upright partitions (also called lattice paths hereinafter), by using path partitions above the core. The gas-liquid two-phase flow that ascends from the core may also be led in the vertical direction(see U.S. Pat. 5,180,547 (Column 1, lines 38 to 44) corresponding to Japanese Patent Journal No. Hei 7(1995)-027051 (Paragraph starting 10 lines from the bottom of the left column on Page 2) for example).

### SUMMARY OF THE INVENTION

In the conventional natural circulation type boiling water reactor which has these lattice paths in the chimney, as shown in the example of FIG. 2, the gas-liquid two-phase flow which ascends from each fuel assembly 21 in the core 7 passes through the lattice path 11a of the chimney 11. All of the gas-liquid two-phase flow exhausted from the lattice path 11a joins together at the plenum 11c and the pressure becomes uniform. Thus, in order to precisely perform the thermal margin evaluation for the core 7 using the path distribution calculation for each fuel assembly, a three-dimensional neutronic and thermal-hydraulic coupling calculation method including the complex procedure of evaluating the void fraction and the flow rate in the lattice path 11a between the upper plenum 11c and the lower plenum 10 which is a uniform pressure space, and performing the flow distribution calculation of the core 7 in tandem with this calculation, was necessary.

As a result, the object of this invention is to provide a natural circulation type boiling water reactor in which thermal margin evaluation by flow distribution calculation for each fuel assembly is on par with that of the conventional forced circulation type boiling water reactor without the need for the void fraction and flow rate evaluation in the lattice path of the chimney.

The natural circulation type boiling water reactor of the present invention comprises: a core in which a plurality of fuel assemblies are loaded; a chimney which is disposed above the core and has path partitions which lead the coolant which ascends from the core to a plurality of vertical lattice paths; and a space which does have the path partitions is provided at the lower portion of the chimney.

According to the present invention, a natural circulation type boiling water reactor can be provided in which thermal margin evaluation of the core with high accuracy on par with that of the forced circulation type boiling water reactor is possible, and economic efficiency is improved due to increased rated reactor power and the like.

### BRIEF DESCRIPTION OF THE DRAWINGS

FIG. 1 is a view showing the schematic structure of the natural circulation type boiling water reactor of an embodiment of the present invention.

FIG. 2 is a structural drawing showing an example of a prior art of a natural circulation type boiling water reactor.

FIG. 3 is a structural drawing showing an example of a prior art of a forced circulation type boiling water reactor.

### DETAILED DESCRIPTION OF THE EMBODIMENT

The embodiments of the present invention will be described in detail with reference to the drawings.

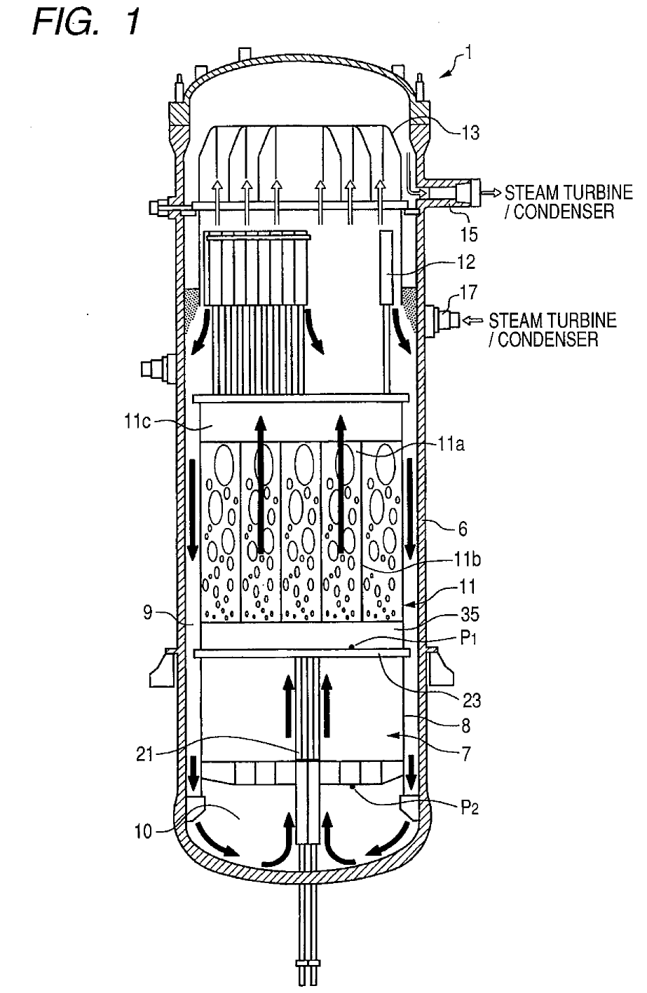

As shown in FIG. 1, a natural circulation type boiling water reactor 1 has a reactor pressure vessel 6. A core 7 in which a plurality of fuel assemblies 21 are loaded, a cylindrical core shroud 8 which encloses the outer periphery of the core 7, an upper core plate 23 which is disposed the upper part of the core 7, a cylindrical chimney 11 which is arranged upright on the upper core plate 23, a steam separator 12 that is loaded on the chimney 11 and has a standpipe for covering the upper end of the chimney 11 and a steam dryer 13 which is mounted above the steam separator 12 so as to enclose the steam separator 12 at the lower skirt portion, are provided in the reactor pressure vessel 6. The reactor pressure vessel 6 has a steam outlet nozzle 15 and feed water inlet nozzle 17.

A path partitions 11b which have a rectangular lattice shape when viewed from above, is disposed in the cylindrical space in the chimney 11. Each metal plate which form a plurality of sides of the lattices of the path partition lib are joined by welding or the like to the adjacent plates. Thus, the path partition 11b is a welded structure. The region in the chimney 11 is partitioned by the path partitions 11b, and in the region, multiple lattice paths 11a are formed in the vertical direction.

Each cross section of each lattice path 11a form rectangular and there is each upper open end of lattice paths 11a is lower than the upper end of the chimney 11. The upper plenum 11c formed between each open end of lattice paths 11a and the upper end of the chimney 11 is a continuous region with a cross section being not partitioned by the lattice.

There is an uniform pressure space 35 which does not have the path partition 11b as is the case with the upper plenum 11c, between the core 7 and the chimney 11.

The cooling water which is light water is poured into the reactor pressure vessel 6 as the coolant at a height at some point on the steam separator 12. When the reactor is operated, the cooling water in the core 7 receives heat generated by the nuclear reaction from nuclear fuel that is stored in the fuel assembly 2. The cooling water that is heated by this heat becomes the two-phase flow including the saturated water and the steam. Because the average density of the two-phase flow is low, the two-phase flow ascends naturally by passing in the core 7 through the uniform pressure space 35 and then is introduced to the lattice paths 11a.

The two-phase flow also passes through the steam separator 12 via the upper plenum 11c. The cooling water being included the two-phase flow is separated from the two-phase flow when it passes through the steam separator 12. The separated cooling water is led to the downcomer 9 which is the perpendicular path between the inner surface of the reactor pressure vessel 6, and the core shroud 8 and the chimney 11. The cooling water flows further down stream in the downcomer 9 which is the coolant descending path.

The steam separated at the steam separator 12 is further led to the steam dryer 13 in order to remove moisture. After sufficient moisture separation is performed at the steam dryer 13, the steam is exhausted from the reactor pressure vessel 6 through the steam outlet nozzle 15 and introduced to main steam pipe (not shown). This steam is supplied the steam turbine (not shown) and used as drive energy of the turbine. It is to be noted that in some cases the steam separator 12 is not provided and moisture separation is performed only by the steam dryer 13.

The steam used in the steam turbine is condensed in a condenser (not shown) and reconverted to water. The water is supplied into the reactor pressure vessel 6 via the feed water inlet nozzle 17 as the feed water. The feed water is mixed with the cooling water that is flowing in the downcomer. The feed water mixed with the cooling water descends in the downcomer.

The flow of the cooling water in the nuclear reactor vessel 6 includes the descending flow in the downcomer 9 and the ascending flow in the core 7 and the chimney 11. Because the ascending flow of the cooling water contains the steam generated in the core 7, the density of the two-phase flow that is the ascending flow is smaller than that of the cooling water that is the descending flow. For this reason, because there is a density head difference between the cooling water that is the descending flow in the downcomer 9 and the two-phase flow that is the ascending flow in the core 7 and the chimney 11, the force circulating the cooling water in the reactor pressure vessel 6. Thus, the cooling water descends in the downcomer 9, and is introduced to the core 7 through the lower plenum 10.

Since the natural circulation boiling water reactor 1 utilizes the density head difference to circulate the cooling water naturally, unlike the conventional forced circulation type boiling water reactor, the natural circulation boiling water reactor 1 do not have system and device for circulating the cooling water. In addition, commonly, heat distribution is generated in the cross-sectional plane in which the heating range of the cooling water in the core 7 is high in the core center section and low in the peripheral portions. Due to this heat distribution, a distribution in the ascending velocity of the cooling water is generated, and the flow tends to become various conditions. This embodiment can prevent these condition changes by minutely partitioning the path of coolant flow using the lattice paths 11a. Thus, drifting and the like of the steam is prevented and the cooling water is circulated stably and efficiently.

As described above, this embodiment has a uniform pressure space 35 in which the pressure becomes uniform, formed in the lower end of the chimney 11. In the case where flow distribution calculation is performed for each of the fuel assemblies 21 in the core 7, the pressure difference between point P₁ of the upper end of the core 7 (above the upper core plate 23) and point P₂ of the lower end of the core 7 (upper end of the lower plenum 10) for example, is calculated and flow distribution for each fuel assembly can be obtained.

The flow distribution for each fuel assembly can be obtained based on the pressure difference obtained by this calculation, using the flow distribution calculation of the conventional forced circulation type boiling water reactor. This calculation is known and may be referred to in the reference below.

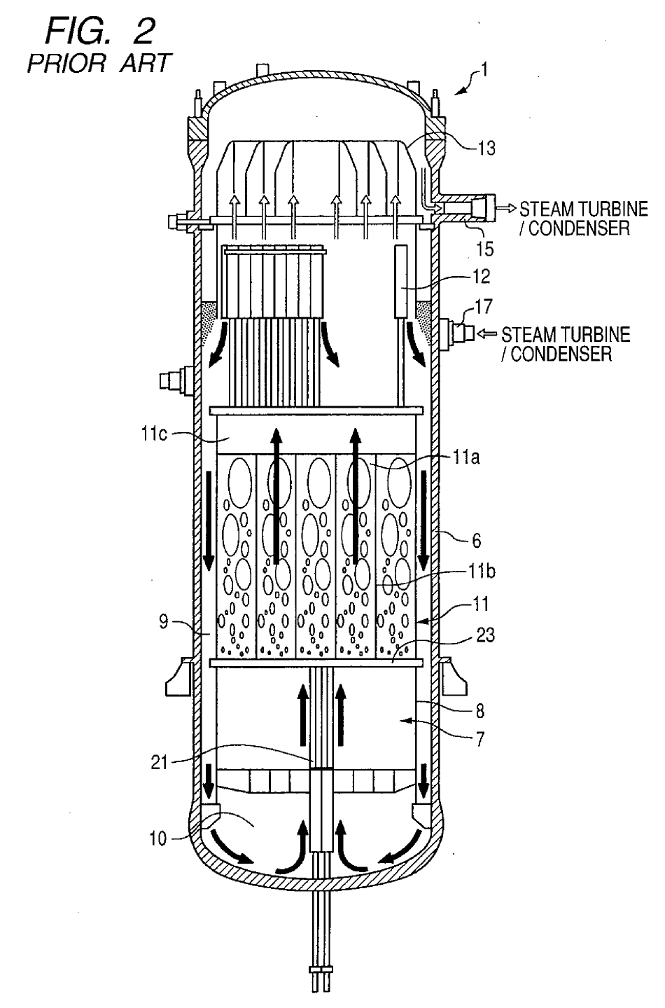

HRL-006 Edition 1 “Boiling Water Reactor Generation Site—Three-dimensional Neutronic or Thermal-hydraulic Coupling Calculation Method” Sep. 1984, Published by Hitachi, FIG. 2 Flow distribution calculation flowchart.

It is to be noted the pressure difference is a common value for each of the fuel assemblies 21, but the reactor power and void fraction for each fuel assembly 21 differs due to the period being loaded in the core and the like. Thus, the flow distribution for each fuel assembly 21 is calculated and thermal margin evaluation of the core 7 is performed.

The example of the conventional forced circulation type boiling water reactor which is based on the known flow distribution calculation method is compared with this embodiment.

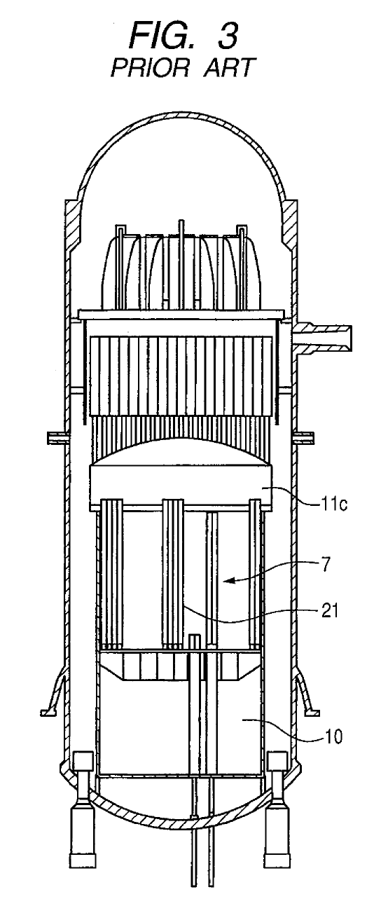

In the conventional forced circulation type boiling water reactor shown in FIG. 3, the upper plenum 11c is disposed above the core 7 loading a plurality of fuel assemblies 21, as the uniform pressure space. Further, the lower plenum 10 is disposed at the lower side of the core 7. In this conventional forced circulation type boiling water reactor, it is supposed that the pressure difference between the upper plenum 11c and the lower plenum 10 operates commonly on each fuel assembly 21. The flow distribution for each fuel assembly 21 is calculated based on this supposition using the known flow distribution calculation method, and the thermal margin evaluation for the core 7 can be performed by using the calculated flow distribution.

That is to say, because upper plenum 11c shown in FIG. 3 is equivalent to the uniform pressure space 35 of this embodiment (FIG. 1), and the core 7 and the surrounding structures are the same as this embodiment, thus the pressure difference between the point P₁ and the point P₂ of this embodiment is calculated using the known flow distribution method and thermal margin evaluation of the core 7 can be performed.

Next, the height that can be used as the uniform pressure space 35 in this embodiment will be described.

First, in order that pressure of the uniform pressure space 35 becomes uniform, a time t is required for being transmitted pressure from one end of the uniform pressure space 35 to the other end of the uniform pressure space 35. Acoustic velocity is one indicator of effective pressure transmission. However, because the void fraction of the core upper portion is generally 50% or more, or in other words, the volume of the steam in the two-phase flow is greater than that of the liquid, the acoustic velocity v in the steam is used as the indicator for pressure transmission.

Because the chimney 11 is cylindrical, the distance from one end to the other end of the uniform pressure space 35 in the horizontal cross-section is equal to the inner diameter D of the chimney 11.

Thus, the time t that is required for transmitting pressure in the uniform pressure space 35 can be obtained using the following calculation formula.
t=D/v (1)

During this time t, if the uniform pressure space 35 is of a height that is greater than the distance h which the steam ascends in the uniform pressure space 35, the conditions can be satisfied for allowing uniform pressure. That is to say, given that the ascending velocity of the steam is U, the lower limit Hmin for height of the uniform pressure space 35 can be obtained by the calculation formula (2) below.
Hmin=h=U×t=U×D/v or
Hmin=U×D/v (2)

If, for example, the inner diameter of the chimney is 6.0 m, the ascending velocity of the steam is 5.0 m/s, and the acoustic velocity in the steam is 488 m/s (when the pressure is saturated steam of approximately 7.2 MPa) and these are substituted in calculation formula (2), it is clear that the lower limit Hmin of the height for making the pressure in the uniform pressure space 35 uniform is 6.15 cm.

Next, the upper limit Hmax of the height of the uniform pressure space 35 will be described.

In the case where the height of the uniform pressure space 35 is made higher than necessary, the steam collects in the center portion of the path in the space 35, and the steam velocity in the center potion increases, and the cooling water collects in the path outer periphery side. Thus, the drifting phenomenon occurs in the uniform pressure space 35. When this drifting phenomenon occurs, in the natural circulation type boiling water reactor 1, the steam collects the center potion in the cross-section plane of the chimney 11. A reduction of the void fraction of the entire chimney is caused by the increased flow rate of the steam in the center potion. Accordingly, natural circulation flow rate of the cooling water is reduced. If the height of the uniform pressure space 35 to prevent drift generation is such that Hmax is 1 m based on the example of the upper plenum 11c of the conventional forced circulation type boiling water reactor, no problems arise and there is no adverse effect on the circulation properties in the chimney 11.

It is to be noted that a possible modification of the pressure difference calculation in this embodiment is that the pressure difference between the point P₁ and the point P₂ may be obtained by measurement using a pressure difference sensor or the like. In this case, if the position of the measurement position for the upper end of the core 7 is inside the uniform pressure space 35, pressure equal to the pressure at the point P₁ can be obtained and thus other points on the upper portion lattice plate can be used and side wall points may also be used as the measurement positions. Because the lower plenum 10 is a space where the cooling water flows as a liquid and thus, it is not problematic for the pressure difference measurement position at the lower end of the core 7 to have the same height as the point P₂. Alternatively, if pressure correction using the density head pressure difference inside the lower plenum 10 is possible, even a measurement position that has a height that is different from that of the point P₂ can be used as the pressure difference measurement position.

In this manner, in the natural circulation type boiling water reactor, by providing the uniform pressure space 35 at the lower portion of the chimney 11, the void fractions of the lattice paths inside the chimney are evaluated, and there is no need to use complex three-dimensional neutronic or thermal-hydraulic coupling calculation codes such as obtaining the cooling water flow rate of each fuel assembly corresponding to each lattice path. In this case, it is necessary to use correlations etc. for evaluation using analysis of the void fraction in the chimney and this causes errors. In the case where the void fraction is actually measured by the natural circulation type boiling water reactor, the measuring system must be installed in the rector that is high temperature and high pressure and this is costly. In this embodiment, thermal margin evaluation of the core with high accuracy on par with the performance of the forced circulation type boiling water reactor becomes possible and increase in reactor output also becomes possible.

What is claimed is:

1. A natural circulation type boiling water reactor which comprises:
a reactor pressure vessel;
a core for loading a plurality of fuel assemblies;
a chimney disposed above the core and having path partition forming a plurality of vertical lattice paths for introducing the coolant exhausted from the core;
and a space formed at the lower portion of the chimney and not having the path partitions.

2. The natural circulation type boiling water reactor according to claim 1, wherein given that the flow velocity of the steam ascending said space
is U; the inner diameter of said space is D; and the acoustic velocity of the steam in said space is v,
the lower limit Hmin of the height of said space in order for the pressure in the space to be uniform is obtained by a calculation formula Hmin=U×D/v.
